(19) United States
(12) Patent Application Publication
(10) Pub. No.: US 2013/0190001 A1
(43) Pub. Date: Jul. 25, 2013

(54) METHOD AND APPARATUS FOR PROVIDING LOCATION INFORMATION IN A WIRELESS COMMUNICATION SYSTEM

(71) Applicant: Innovative Sonic Corporation, Taipei City (TW)

(72) Inventors: Yu-Hsuan Guo, Taipei City (TW); Meng-Hui Ou, Taipei City (TW)

(73) Assignee: Innovative Sonic Corporation, Taipei City (TW)

(21) Appl. No.: 13/744,698

(22) Filed: Jan. 18, 2013

Related U.S. Application Data
(60) Provisional application No. 61/588,370, filed on Jan. 19, 2012.

(51) Int. Cl. H04W 4/02

(52) U.S. Cl. CPC H04W 4/02
USPC 455/450

(57) ABSTRACT

A method and apparatus are disclosed for providing location information in a wireless communication network. The method includes initiating a transmission of the UE's location information to the network when a positioning status of the UE becomes available or when the UE needs to provide the positioning status to the network.

### CROSS-REFERENCE TO RELATED APPLICATIONS

The present Application claims the benefit of U.S. Provisional Patent Application Ser. No. 61/588,370 filed on Jan. 19, 2012, the entire disclosure of which is incorporated herein by reference.

### FIELD

This disclosure generally relates to wireless communication networks, and more particularly, to a method and apparatus for providing location information in a wireless communication network.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services,

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for providing location information in a wireless communication network. The method includes initiating a transmission of the UE's location information to the network when a positioning status of the UE becomes available or when the UE needs to provide the positioning status to the network.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also blown as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a flowchart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access TDMA), orthogonal frequency division multiple access (OFDMA), 3GPP LTE (Long Term Evolution) wireless access, 3GPP LTE-A or LTE-Advanced (Long Terni Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos., 36PP TS 36.331 V10.4.0, “E-UTRA; RRC protocol specification”; RP-111361, “Enhancement of Minimization of Drive Tests for E-UTRAN and UTRAN”; RAN2#76 Draft Meeting Notes (available at http://www.3gpp.org/ftp/tsg_ran/WG2_RL2/TSGR2_{—}76/Report/); [76#34] MDT location information enhancements; R2-116135, “Requirements, Priority and Solution for MDT Location Information Enhancement”, NTT DOCOMO; TS 36.305 V10.3.0, “Stage 2 functional specification of UE positioning in E-UTRAN”; and TS 36.321 V10.4.0, “E-UTRA; MAC protocol specification”. The standards and documents listed above are hereby expressly incorporated herein.

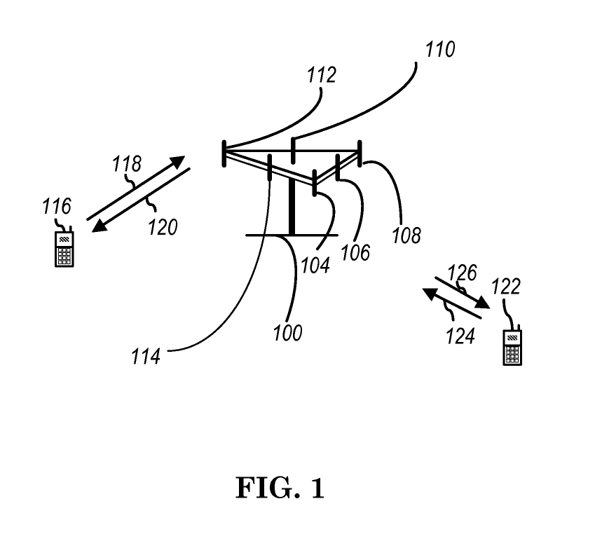

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to au its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

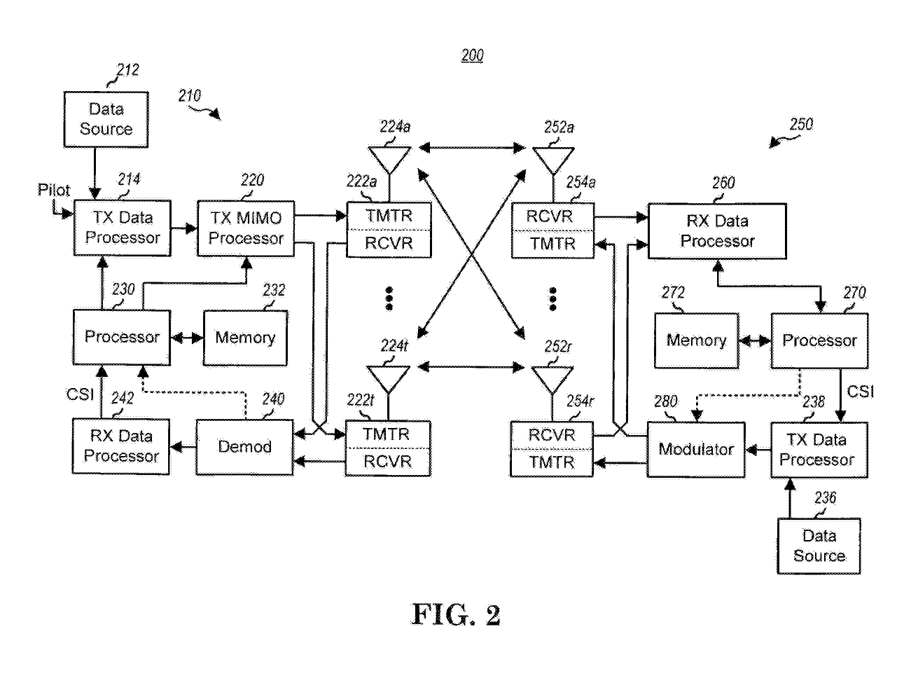

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t, In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the channel. N_{T} modulated signals front transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r, Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R}, receivers 254 based on a particular receiver processing technique to provide N_{T} “detected” symbol streams, The RX data processor 260 then demodulates, deinterleaves, and decodes each detected symbol Stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data Streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222 demodulated by a demodulator 240, and processed by a RX data processor 242 to extract the reserve link message transmitted by the receiver system 250. Processor 230 then determines which pre-coding matrix to use for determining the beamforming weights then processes the extracted message.

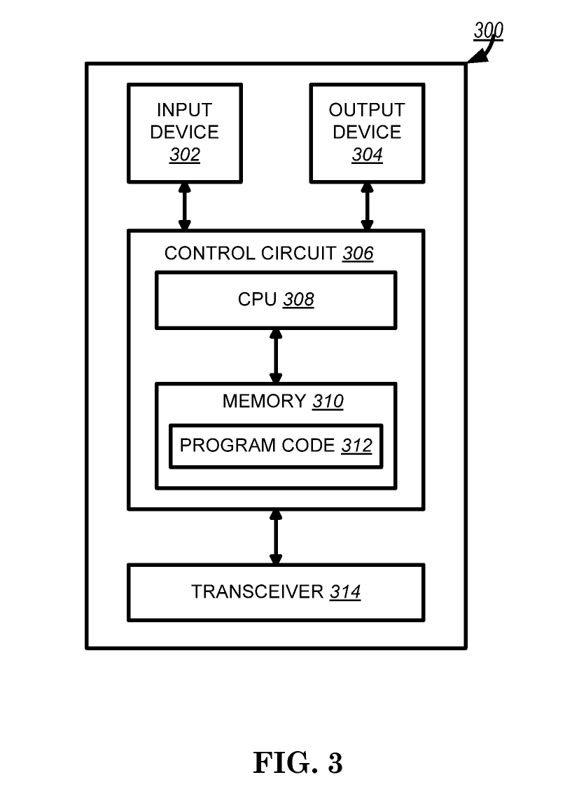

Turning to FIG. 3, this figure shows an alternative simplified functional block diagram of a communication device according to one embodiment of the invention. As shown in FIG. 3, the communication device 300 in a wireless communication system cart be utilized for realizing the UEs (or ATs) 116 and 122 in FIG. 1, and the wireless communications system is preferably the LTE-A system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 106, and outputting signals generated by the control circuit 306 wirelessly.

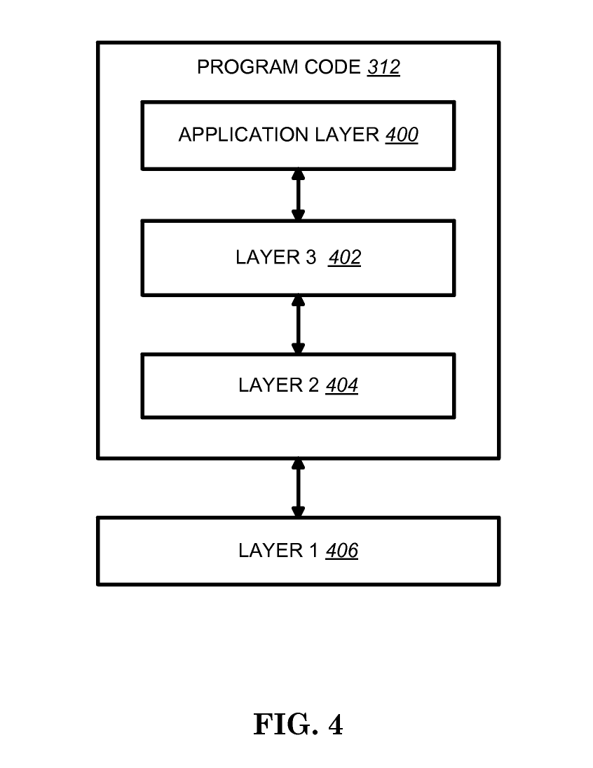

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406, The Layer 3 portion 402 generally performs radio resource control. The Layer 2 portion 404 generally performs link control. The Layer 1 portion 406 generally performs physical connections.

3GPP TS 36.331 includes details for Minimization of Drive Tests (MDT). In general, the detailed location information, if available, could be carried by an IE (Information Element) called locationInfo which is included in a UEInformationResponse message or a MeasurementReport message.

As indicated in 3GPP RP-111361, a work item “enhancement of Minimization of Drive Tests for E-UTRAN and UTRAN” for Rel-11 is under discussion. 3GPP RP-111361 provides the following Justifications and/or objectives for the work item:
Using drive tests for network optimization purposes is costly and causes also additional CO2 emissions, so it is desirable to have automated solutions, including involving UEs the field, to reduce the operator costs for network deployment and operation. This WI intends to continue the Rel-9 and Rel-10 work on defining the solutions for Minimization of Drive Tests (MDT).
The solutions developed in Rel-10 focused on coverage optimization and did not address one of the most typical use eases for drive testing, namely QoS verification, which has been investigated in the study item and found beneficial. Rel-10 solutions also come With other limitations, such as limited probability to get detailed positioning information correlated with radio measurements. For Drive Testing, location information is crucial,
The following general enhancements will be addressed:
   Common for the above use cases, improvement on solutions to obtain detailed location information for MDT should be considered. The improvement should focus on increasing the availability of detailed location information when MDT measurement is taken or collected. Hence, extending already defined options for MDT positioning, including the use of 3GPP specified positioning methods, should be pursued.

Based on the RAN2#76 Draft Meeting Notes, the following, agreements have been made during the RAN2#76 meeting;
1. An attempt will be made to enhance availability of detailed location information for immediate and logged MDT.
2. It should be possible to avoid MDT measurements that do not have detailed location information available.
3. For UEs in RRC Connected it should be possible to request additional location information for MDT purpose (i.e., “on-demand” location information for MDT).
   For Future Study (FFS)—whether this applies also for UEs in. IDLE, i.e., logged MDT. If supported for logged MDT, this should not require the UE to enter RRC Connected to obtain location information.
   For Future Study (FFS)—whether restrictions when to use this need to be defined.

Currently, as indicated in the 3GPP document entitled “[76#34] MDT location information enhancements”, a discussion about MDT location enhancements is on-going. In general, the scope of the discussion is to continue the discussion of the two main tracks (including requesting MDT for terminals having location information available anyway as well as the possibility to request the UE (User Equipment) to obtain location information for the Purpose of MDT). In one of the possible solutions, the network would initiate MDT for a UE (or select the UE for MDT) when positioning is on-going for the UE and the positioning status is indicated by the UE to the network.

3GPP R2-116135 also proposes a similar solution in which the UE would indicate to the network that the UE has active location information session, such as UPS (Global Positioning System) receiver miming, active LCS (Location Services) session (as specified in 3GPP TS 36.305 V10.3.0), or active SUPL (Secure User Plane Location) session (as specified in 3GPP TS 36.305 V10.3.0), or other active location information session. Furthermore, there are two further options proposed for this solution in 3GPP document entitled “[76#34] MDT location information enhancements), including (i) the UE would keep the network up to date with respect to positioning status, and (ii) the UE would indicate positioning status to the network only on immediate request.

Assuming that the UE informs its positioning status (such as about whether positioning procedure is on-going, whether detailed location information is available, or whether GPS is enabled) to the network. The network could choose the UE having detailed location information to perform MDT related functionalities (such as logged MDT or immediate MDT). However, MDT may only be required to acquire coverage or QoS information for a specific area in Rel-11. Thus the network may not, need the coverage or QoS information for other areas which are already stable in Rel-10. Under this assumption, positioning status may not be sufficient for the network to decide which UE should perform MDT related functionalities. Improper selection of UEs to perform MDT related functionalities would result in the waste of UE power and radio resource,

In general, when a UE changes its positioning status from “not available” to “available”, the UE could provide its location information to network. Alternatively, when a UE needs to inform its positioning status to the network, the UE could provide its location information to the network if the positioning status is available. The positioning status and the location information could be transmitted together in the same message, such as a RRC (Radio Resource Control) message, The location information may include UE position, UE velocity, UE moving direction, and/or UE mobility state. Upon receipt of the location information, the network could select a UE to perform MDT related functionalities based on the UE positioning status and on whether the UE is in the concerned area.

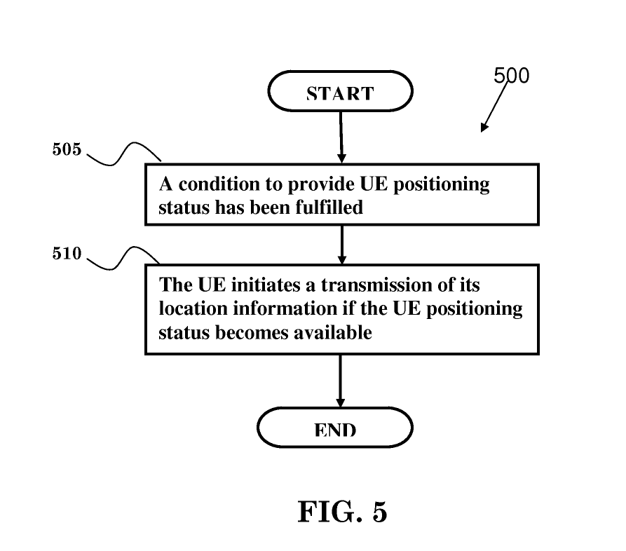

FIG. 5 illustrates a flowchart 500 according to one exemplary embodiment. In step 505, a condition to provide UE positioning status has been fulfilled. In step 510, the UE initiates a transmission of its location information if the UE's positioning status becomes available. In one embodiment, the availability of the positioning status may mean: (i) a positioning procedure is on-going, (ii) detailed location information is available, (iii) GPS is enabled, (iv) OPS receiver is running, (v) GNSS (Global Navigation Satellite System) is enabled, and/or (vi) LCS session, location information session, or SUPL (Secure User Place Location) session is active.

Referring back to FIGS. 3 and 4, the LIE 300 includes a program code 312 stored in memory 310. In one embodiment, the CPU 308 could execute the program code 312 to initiate a transmission of a UE's location information to the network when a positioning status of the UE becomes available or when the UE needs to provide the positioning status to the network. In one embodiment, the UE needs to inform its positioning status to the network if it receives a request for positioning status or location information, if the positioning status changes, or if the positioning status becomes available for the first time after activating a method to acquire position, such as GNSS, UPS, LCS, or SUPL. The LIE may activate a method to acquire position, such as GNSS, GPS, LCS, or SUPL, due to the reception of the request. Furthermore, the location information could be the IE (Information Element) locationInfo. Also, the location information could include the position (e.g. longitude and latitude), the velocity, the moving direction, and/or the mobility state of the UE. In this embodiment, the positioning status of the UE would become available (i) when there is an ongoing positioning procedure in the UE, (ii) when the UE has its detailed location information, (iii) when the GPS or GNSS of the UE is enabled, (iv) when the GPS or GNSS receiver of the UE is running, and/or (v) when a LCS session, a location information session, or a SUPL session is active in the UE.

In one embodiment, the location information and the positioning status could be transmitted in the same TTI (Transmission Time Interval). Furthermore, the location information and the positioning status could be included in the same RRC message. Alternatively, the location information could be transmitted (alone) through a RRC message (Such as a MeasurementReport message), or could be included in a MAC (Medium Access Control) control element. The MAC control element could further include buffer status or power headroom information.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above, description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing location information by a user equipment (UE) wherein the UE is in a RRC (Radio Resource Control) connected mode in a wireless network, comprising:
initiating a transmission of the UE's location information to the network when a positioning status of the UE becomes available or when the UE needs to provide the positioning status to the network.

2. The method of claim 1, wherein the UE needs to provide the positioning status to the network if the UE receives a request for positioning status or location information, if the positioning status changes, or if the positioning status becomes available for the first time after activating a method to acquire position.

3. The method of claim 1, the location information and the positioning status are transmitted in a RRC message and within a TTI (Transmission Time Interval).

4. The method of claim 1, wherein the location information is transmitted in a RRC message or in a MAC (Medium Access Control) control element.

5. The method of claim 1, wherein the location information includes a longitudinal position, a latitudinal position, a velocity, a moving direction, and/or a mobility state of the UE.

6. The method of claim 1, wherein the positioning status of the UE becomes available when a positioning procedure occurs in the UE, the UE has its detailed location information, a GPS (Global Positioning System) or GNSS (Global Navigation Satellite System) in the UE is enabled, and/or a GPS or GNSS receiver in the UE is running.

7. The method of claim 1, wherein the positioning status of the UE becomes available when a LCS (Location Services) session, a location information session, and/or a SUPL (Secure User Plane Location) session is active in the UE.

8. A communication device for providing location information by a user equipment (UE) wherein the UE is in a RRC (Radio Resource Control) connected mode in a wireless network, the communication device comprising:
a control circuit;
a processor installed in the control circuit;
a memory installed in the control circuit and operatively coupled to the processor;
wherein the processor is configured to execute a program code stored in memory to provide location information by:
initiating a transmission of the UE's location information to the network when a positioning status of the UE becomes available or when the UE needs to provide the positioning status to the network.

9. The communication device of claim 8, wherein the UE needs to provide the positioning status to the network if the UE receives a request for positioning status or location information, if the positioning status changes, or if the positioning status becomes available for the first time after activating a method to acquire position.

10. The communication device of claim 8, the location information and the positioning status are transmitted in a RRC message and within a TTI (Transmission Time Interval).

11. The communication device of claim 8, wherein the location information is transmitted in a RRC message or in a MAC (Medium Access Control) control element.

12. The communication device of claim 8, wherein the location information includes a longitudinal position, a latitudinal position, a velocity, a moving direction, and/or a mobility state of the UE.

13. The communication device of claim 8, Wherein the positioning status of the UE becomes available when a positioning procedure occurs in the UE, the UE has its detailed location information, a GPS (Global Positioning System) or GNSS (Global Navigation Satellite System) in the UE is enabled, and/or a GPS or GNSS receiver in the UE is running.

14. The communication device of claim 8, wherein the positioning status of the UE becomes available when a LOS (Location Services) session, a location information session, and/or a SUPL (Secure User Plane Location) session is active in the UE.
